(19) United States
(12) Patent Application Publication
(10) Pub. No.: US 2026/0216926 A1
(43) Pub. Date: Jul. 30, 2026

(54) MOLD SET, METHOD FOR MANUFACTURING STRAW USING MOLD SET, AND STRAW

(71) Applicant: KANEKA CORPORATION, Osaka (JP)

(72) Inventors: Kengo Fukushima, Osaka (JP); Tomoaki Hashiguchi, Osaka (JP); Yasushi Noda, Osaka (JP)

(73) Assignee: KANEKA CORPORATION, Osaka (JP)

(21) Appl. No.: 19/629,731

(22) Filed: Mar. 26, 2026

Related U.S. Application Data
(63) Continuation of application No. PCT/JP2024/026915, filed on Jul. 29, 2024.

(30) Foreign Application Priority Data
Sep. 28, 2023 (JP) 2023-168349

(51) Int. Cl. B29C 33/42; A47G 21/18; B29C 53/30; B29K 67/00; B29L 23/00

(52) U.S. Cl. CPC B29C 33/42; A47G 21/18; B29C 53/30; B29K 2067/04; B29L 2023/008

(57) ABSTRACT

A mold set for manufacturing a straw having a bellows structure is provided. The straw includes an aliphatic polyester-based resin. In the mold set, each peak portion of an inner mold has a top portion having a rounded surface, and each peak portion of an outer mold has a top portion having a rounded surface. In an LD direction, each peak portion of the inner mold has a length of 1.50 mm to 1.80 mm, and each peak portion of the outer mold has a length of 1.50 mm to 1.80 mm.

### TECHNICAL FIELD

One or more embodiments of the present invention relate to a mold set, a method for manufacturing a straw using a mold set, and a straw.

### BACKGROUND

In order to achieve a straw that can be extended and contracted or that can be bent, a technology for forming a bellows structure on a straw body as an extendable/contractible portion or a bend portion is known. For example, Patent Literature 1 discloses a straw made of a thermoplastic resin and having an extendable/contractible portion. The extendable/contractible portion of Patent Literature 1 has small-diameter portions, large-diameter portions, and inclined side portions located between the small-diameter portions and the large-diameter portions, and has a structure in which the small-diameter portions and the large-diameter portions are alternately connected via the side portions. In a contracted state of the extendable/contractible portion of Patent Literature 1, the side portions are folded back with respect to the small-diameter portion and the large-diameter portion, so that they overlap. Patent Literature 1 also discloses a mold set for forming the extendable/contractible portion.

Further, although not a technology related to a straw made of a thermoplastic resin, Patent Literature 2 discloses a technology for forming a bellows by forming an uneven surface on an outer surrounding wall of a raw pipe constituted by a thin-walled cylindrical body. The technology of Patent Literature 2 uses a mold constituted by a male mold having an uneven portion along its circumferential direction on an outer surrounding surface and a female portion that meshes with the uneven surface of the male mold. Then, the outer surrounding wall of the raw pipe is interposed between the male mold and the female mold, and the bellows is formed by pressing the female mold into the male mold while rotating the male mold.

Aliphatic polyester-based resins are used for various applications. Among them, biodegradable resins such as poly(3-hydroxyalkanoate)-based resins (hereinafter, may be referred to as “P3HA-based resins”) are attracting attention as environmentally friendly resins due to their biodegradability. Attempts have been made to develop a straw having a bellows structure by using such a biodegradable resin as a raw material.

### CITATION LIST

### [Patent Literature 1]

Japanese Patent Application Publication, Tokukaisho, No. 59-020120

### [Patent Literature 2]

Japanese Patent Application Publication, Tokukaisho, No. 58-131036

However, when a bellows structure of a straw is formed using an aliphatic polyester-based resin such as a biodegradable resin as a raw material with use of the mold set of Patent Literature 1 or 2, there is a problem in that bend portions of the bellows structure are crushed or broken, and a practically usable straw cannot be manufactured. Therefore, the mold sets of Patent Literatures 1 and 2 have room for improvement in that they cannot be used for manufacturing a straw with a bellows structure using an aliphatic polyester-based resin such as a biodegradable resin as a raw material.

### SUMMARY

One or more embodiments of the present disclosure are directed to a mold set usable for manufacturing a straw with a bellows structure using an aliphatic polyester-based resin such as a biodegradable resin as a raw material, a straw manufacturing method using the mold set, and a straw.

A mold set in accordance with one or more embodiments of the present disclosure is a mold set for forming a bellows structure on a straw body having a tubular shape, the mold set including: an inner mold having a rod shape and configured to be inserted into the straw body; and an outer mold having a rod shape and configured to press the straw body from an outer side, wherein the inner mold has a first uneven portion that forms mountain fold portions of the bellows structure, the first uneven portion includes a first shaft portion extending in an axial direction of the straw body and a plurality of first peak portions protruding in a radial direction of the inner mold with respect to the first shaft portion and provided at a predetermined interval in the axial direction of the straw body, the outer mold has a second uneven portion that forms valley fold portions of the bellows structure, the second uneven portion includes a second shaft portion disposed in parallel with the first shaft portion and a plurality of second peak portions protruding in a radial direction of the outer mold with respect to the second shaft portion, each of the plurality of second peak portions being inserted between two adjacent first peak portions, each of the plurality of first peak portions has a first top portion having a rounded surface, each of the plurality of second peak portions has a second top portion having a rounded surface, in the axial direction of the straw body, each of the plurality of first peak portions has a length of 1.50 mm to 1.80 mm, and in the axial direction of the straw body, each of the plurality of second peak portions has a length of 1.50 mm to 1.80 mm.

A straw in accordance with one or more embodiments of the present disclosure is a straw in which a bellows structure is formed on a straw body having a tubular shape and containing an aliphatic polyester-based resin, the straw body having a wall thickness of 0.18 mm to 0.22 mm.

According to these aspects of the present disclosure, it is possible to achieve a mold set usable for manufacturing a straw with a bellows structure using an aliphatic polyester-based resin such as a biodegradable resin as a raw material.

### BRIEF DESCRIPTION OF DRAWINGS

FIG. 1 illustrates a schematic configuration of a mold set in accordance with one or more embodiments of the present invention, in which reference numeral 1001 indicates a side view, and reference numeral 1002 indicates a rear view as seen from the rear side.

FIG. 2 is a side view illustrating a schematic configuration of an uneven portion of the inner mold illustrated in FIG. 1.

FIG. 3 is a side view illustrating a schematic configuration of an uneven portion of the outer mold illustrated in FIG. 1.

Reference numerals 4001 to 4003 of FIG. 4 are views schematically illustrating an example of a bellows structure forming step in a method for manufacturing a straw in accordance with one or more embodiments of the present invention.

FIG. 5 is a cross-sectional view mainly illustrating a schematic configuration of a bellows structure of a straw in accordance with one or more embodiments of the present invention.

### DETAILED DESCRIPTION

One or more embodiments of the present invention will be described in detail below. Note that any numerical range expressed as “A to B” in the present specification means “not less than A and not more than B” unless otherwise stated. All literatures listed herein are incorporated herein by reference.

### TECHNICAL IDEAS

As disclosed in Patent Literature 1 and the like, in a technology for forming a bellows structure on a straw body, a mold set including an inner mold and an outer mold is used. The inner mold is inserted into the straw body and has an uneven portion for forming mountain fold portions of the bellows structure. The outer mold presses the straw body from an outer side and has an uneven portion for forming valley fold portions of the bellows structure.

The bellows structure is formed on the straw body through the following steps: a molding step of setting the mold set on the straw body and molding mountain fold portions and valley fold portions of the bellows structure on the straw body by pressing the outer mold against the outer surface of the straw body while rotating the inner mold and the outer mold in opposite directions; and a folding step of, after the molding step, removing the mold set from the straw body and compressing the molded portion of the straw body from both sides to fold the molded portion.

The present inventors have found that in a case where a straw body made of an aliphatic polyester-based resin such as a biodegradable resin as a raw material is used, forming a bellows structure with use of the above-described mold set causes whitening and cracks of ridge line portions of bend portions (valley fold portions or mountain fold portions) of the straw body due to the pressing in the molding step. Further, the present inventors have also found that the compression of the molded portion in the folding step causes whitening and cracks of the ridge line portions of the bend portions of the straw body. Therefore, the present inventors conducted diligent research and development aiming to develop a mold set that can be used for manufacturing a straw with a bellows structure, even in a case where a straw body made of an aliphatic polyester-based resin such as a biodegradable resin as a raw material is used.

The present inventors considered that if a mold set is used which can form a bellows structure on a straw body having a relatively large wall thickness, it would be possible to manufacture a practically usable straw in which no cracks occur in the bend portions of the bellows structure, and that such a mold set can be used for manufacturing a straw with a bellows structure, and the present inventors conducted diligent studies. As a result, the present inventors have found that, for the mold set, by (1) in the axial direction of the straw body, setting the length of each peak portion (protruding portion) of the uneven portion of the inner mold and the length of each peak portion (protruding portion) of the uneven portion of the outer mold within specific numerical ranges and (2) forming the top portion of each peak portion of the uneven portion of the inner mold and the top portion of each peak portion of the uneven portion of the outer mold into rounded surfaces, it is possible to manufacture a practically usable straw with a bellows structure and found that such a mold set can be used for manufacturing a straw with a bellows structure. As a result, the present inventors arrived at the present embodiments.

That is, a mold set in accordance with one or more embodiments is a mold set for forming a bellows structure on a straw body having a tubular shape, the mold set including: an inner mold having a rod shape and configured to be inserted into the straw body; and an outer mold having a rod shape and configured to press the straw body from an outer side, wherein the inner mold has a first uneven portion that forms mountain fold portions of the bellows structure, the first uneven portion includes a first shaft portion extending in an axial direction of the straw body and a plurality of first peak portions protruding in a radial direction of the inner mold with respect to the first shaft portion and provided at a predetermined interval in the axial direction of the straw body, the outer mold has a second uneven portion that forms valley fold portions of the bellows structure, the second uneven portion includes a second shaft portion disposed in parallel with the first shaft portion and a plurality of second peak portions protruding in a radial direction of the outer mold with respect to the second shaft portion, each of the plurality of second peak portions being inserted between two adjacent first peak portions, each of the plurality of first peak portions has a first top portion having a rounded surface, each of the plurality of second peak portions has a second top portion having a rounded surface, in the axial direction of the straw body, each of the plurality of first peak portions has a length of 1.50 mm to 1.80 mm, and in the axial direction of the straw body, each of the plurality of second peak portions has a length of 1.50 mm to 1.80 mm.

A straw in accordance with one or more embodiments is a straw in which a bellows structure is formed on a straw body having a t tubular shape and containing an aliphatic polyester-based resin, the straw body having a wall thickness of 0.18 mm to 0.22 mm.

Hereinafter, one or more embodiments of the present invention will be described with reference to the drawings. As illustrated in the drawings, a length direction (axial direction) of the straw body is referred to as an LD direction, and in the LD direction, one side (front side) is referred to as an LDa side, and the other side (rear side) is referred to as an LDb side.

### (Configuration of Mold Set)

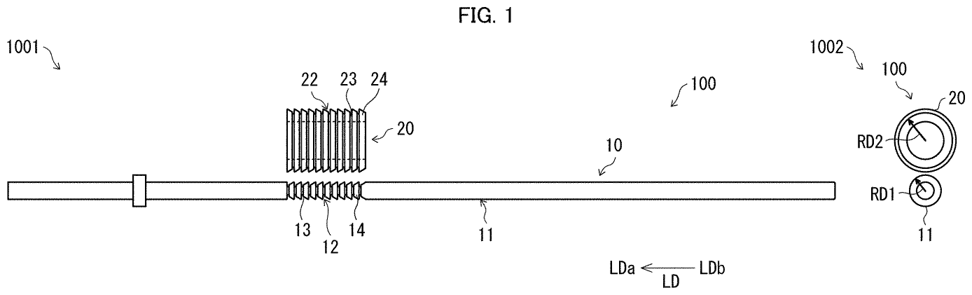

FIG. 1 illustrates a schematic configuration of a mold set 100 in accordance with one or more embodiments, in which reference numeral 1001 of FIG. 1 indicates a side view, and reference numeral 1002 of FIG. 1 indicates a rear view as seen from the LDb side. As illustrated in reference numerals 1001 and 1002 of FIG. 1, the mold set 100 includes an inner mold 10 and an outer mold 20.

The inner mold 10 is a columnar rod member that is inserted into a cylindrical straw body. The diameter of the inner mold 10 is slightly smaller than the inner diameter of the straw body. Here, a radial direction of the inner mold 10 is referred to as an RD1 direction.

The inner mold 10 has a columnar body portion 11 extending in the LD direction, and the body portion 11 has an uneven portion 12 (first uneven portion). The uneven portion 12 forms mountain fold portions of the bellows structure of the straw body. The term “mountain fold portion” as used herein means a bend portion of the bellows structure in which a ridge line is located on an outer side.

The uneven portion 12 has a shaft portion 13 (first shaft portion) and a plurality of peak portions 14 (first peak portions). The shaft portion 13 extends in the LD direction and is coaxial with a portion of the body portion 11 other than the uneven portion 12. The peak portions 14 protrude in the RD1 direction with respect to the shaft portion 13. The peak portions 14 each have a truncated cone shape, with the shaft portion 13 serving as its axis. Further, the peak portions 14 are provided at a predetermined interval in the LD direction.

The outer mold 20 is a member having a cylindrical side surface that presses the straw body from an outer side. The diameter of the outer mold 20 is not particularly limited, but may be 5 mm to 60 mm, or 10 mm to 40 mm. Here, a radial direction of the outer mold 20 is an RD2 direction.

The outer mold 20 is disposed so as to face the uneven portion 12 of the inner mold 10 so that a wall portion of the straw body is sandwiched between the uneven portion 12 of the inner mold 10 and the outer mold 20. The outer mold 20 has an uneven portion 22 (second uneven portion). The uneven portion 22 forms valley fold portions of the bellows structure of the straw body. The term “valley fold portion” as used herein means a bend portion of the bellows structure in which a ridge line is located on an inner side.

The uneven portion 22 has a shaft portion 23 (second shaft portion) and a plurality of peak portions 24 (second peak portions). The shaft portion 23 is disposed so as to be parallel with the shaft portion 13. That is, the shaft portion 23 extends in the LD direction. The peak portions 24 protrude in the RD2 direction with respect to the shaft portion 23. The peak portions 24 each have a truncated cone shape, with the shaft portion 23 serving as its axis. Further, the peak portions 24 are provided at a predetermined interval in the LD direction. Each peak portion 24 is configured to be inserted between two adjacent peak portions 14 in the uneven portion 12.

### (Configuration of Uneven Portion of Inner Mold)

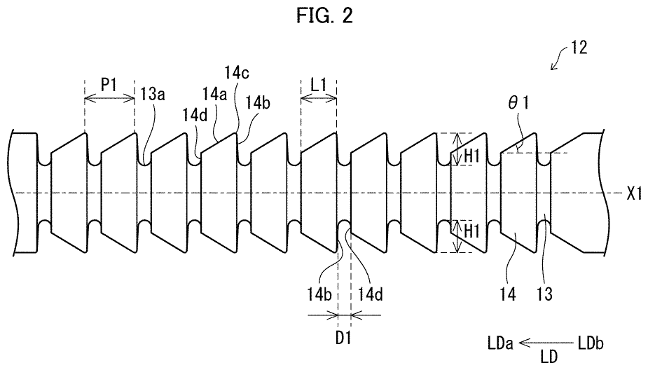

FIG. 2 is a side view illustrating a schematic configuration of the uneven portion 12 of the inner mold 10. As illustrated in FIG. 2, in the uneven portion 12, each peak portion 14 has one top portion 14c (first top portion) and an inclined surface 14a extending from the top portion 14c to the LDa side. More specifically, the peak portion 14 has a truncated cone shape, with an axis X of the shaft portion 13 serving as its axis, and is constituted by the inclined surface 14a, a rear end surface 14b, and a front end surface 14d. The inclined surface 14a is a surface inclined with respect to an axis X1 of the shaft portion 13, and is inclined so that a distance from the shaft portion 13 decreases from the LDb side toward the LDa side. Further, the rear end surface 14b and the front end surface 14d are connected on the LDb side and the LDa side of the inclined surface 14a, respectively. The rear end surface 14b and the front end surface 14d are end surfaces of the peak portion 14 on the LDb side and the LDa side, respectively. Further, the top portion 14c is a connection portion between the inclined surface 14a and the rear end surface 14b, and is a portion of the peak portion 14 that is farthest from the shaft portion 13. The top portion 14c can be said to be an edge portion in the above-described truncated cone shape of the peak portion 14.

The uneven portion 12 has a surface in which a surface 13a of the shaft portion 13, the rear end surface 14b of the peak portion 14, the inclined surface 14a thereof, and the front end surface 14d thereof are alternately repeated from the LDb side toward the LDa side.

In each mountain fold portion of the bellows structure of the straw body, the top portion 14c of the uneven portion 12 forms a ridge line. In the mold set 100 in accordance with one or more embodiments, the top portion 14c of each peak portion 14 has a rounded surface. For this reason, even if an inner surface of the straw body is strongly brought into contact with the uneven portion 12 due to pressing by the outer mold 20, cracks are less likely to occur in the ridge line portion of the bellows structure. This makes it possible to bring the top portion 14c of the uneven portion 12 into contact with the inner surface of the straw body with a strong force in order to form a bend portion of the bellows structure without cracks.

From the viewpoint of bringing the top portion 14c of the uneven portion 12 into contact with a strong force, a radius of curvature of the rounded surface of the top portion 14c may be 0.01 mm to 1.00 mm, or 0.05 mm to 0.20 mm. The radius of curvature of the rounded surface of the top portion 14c is, for example, 0.10 mm.

In the mold set 100, in the LD direction, a length L1 of each peak portion 14 of the uneven portion 12 may be 1.50 mm to 1.80 mm, 1.55 mm to 1.77 mm, or 1.60 mm to 1.75 mm. Setting the length L1 within the above numerical range makes it possible to achieve a mountain fold that can be folded at a ridge line, even if the thickness of the mountain fold portion is relatively large. A bellows structure can be formed even on a straw body having a relatively large wall thickness. The length L1 is, for example, 1.64 mm.

As an inclination angle θ1 of the inclined surface 14a with respect to the shaft portion 13 increases, the top portion 14c of the uneven portion 12 can be brought into contact with the inner surface of the straw body with a greater force. From this viewpoint, the inclination angle θ1 may be 30.0° to 40.0°, or 30.0° to 35.0°. The inclination angle θ1 is, for example, 31.07°.

The larger a distance H1 between the top portion 14c and the shaft portion 13 is, the deeper a recessed groove formed by two adjacent peak portions 14 becomes. If the depth of the recessed groove is great, the top portion 14c of the uneven portion 12 can be brought into contact with the inner surface of the straw body with a strong force. From this viewpoint, the distance H1 between the top portion 14c and the shaft portion 13 may be 1.10 mm to 1.80 mm, or 1.30 mm to 1.70 mm. The distance H1 is, for example, 1.49 mm.

If in the uneven portion 12, a distance (pitch) P1 between two adjacent peak portions 14 is large, the uneven portion 12 enables folding with respect to each mountain fold portion having a relatively large thickness at the ridge line thereof. From this viewpoint, the distance P1 between two adjacent peak portions 14 may be 2.20 mm to 2.50 mm, or 2.25 mm to 2.40 mm. Note that the distance P1 between two adjacent peak portions 14 is intended to mean a distance between two top portions 14c of the two adjacent peak portions 14. The distance P1 is, for example, 2.3 mm.

In two adjacent peak portions 14, a distance D1 between the rear end surface 14b of one peak portion 14 and the front end surface 14d of the other peak portion 14 is not particularly limited, but may be 0.2 mm to 0.8 mm, or 0.4 mm to 0.7 mm. Setting the distance D1 within the above numerical range makes it possible to provide effects of enabling reduction of a contact portion between the straw body and a portion of the uneven portion 12 other than the top portions 14c to improve the appearance of the bellows structure and reducing contact between the straw and the mold other than ridge lines 32d of the straw to improve the appearance. The distance D1 is, for example, 0.6 mm.

### (Configuration of Uneven Portion of Outer Mold)

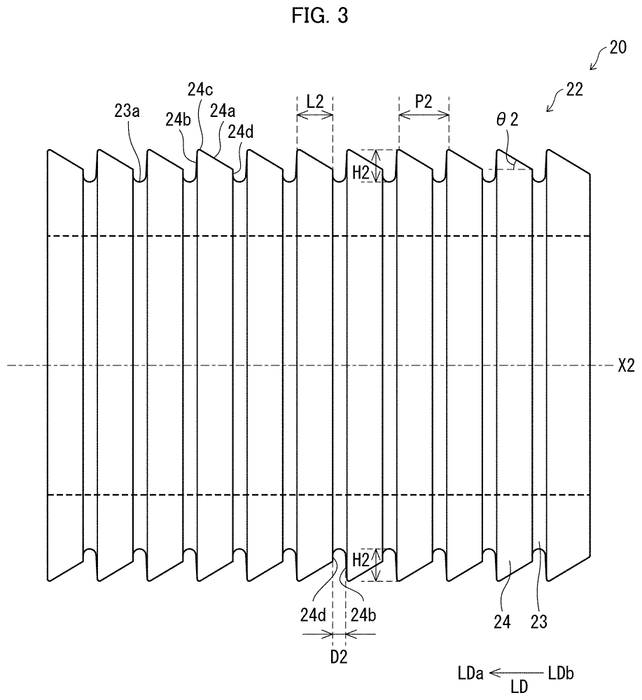

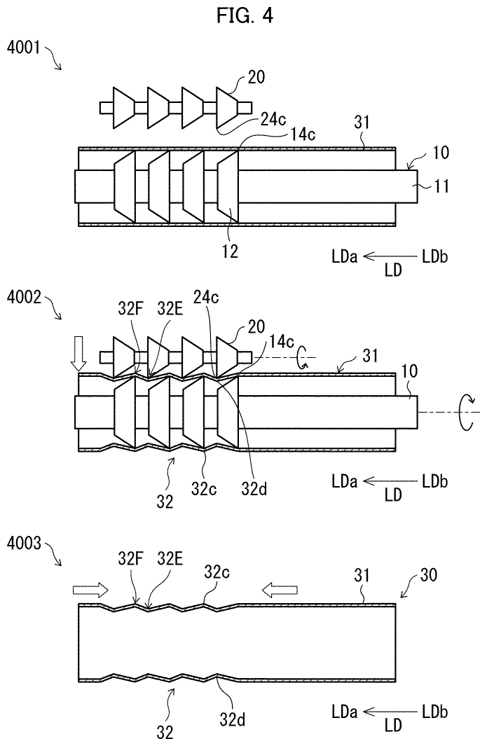

FIG. 3 is a side view illustrating a schematic configuration of the uneven portion 22 of the outer mold 20. As illustrated in FIG. 3, in the uneven portion 22, each peak portion 24 has one top portion 24c (second top portion) and an inclined surface 24a extending from the top portion 24c to the LDb side. More specifically, each peak portion 24 has a truncated cone shape, with an axis X2 of the shaft portion 23 serving as its axis, and is constituted by the inclined surface 24a, a front end surface 24b, and a rear end surface 24d. The inclined surface 24a is a surface inclined with respect to the axis X2 of the shaft portion 23, and is inclined so that a distance from the shaft portion 23 decreases from the LDa side toward the LDb side. Further, the front end surface 24b and the rear end surface 24d are connected on the LDa side and the LDb side of the inclined surface 24a, respectively. The front end surface 24b and the rear end surface 24d are end surfaces of the peak portion 24 on the LDa side and the LDb side, respectively. Further, the top portion 24c is a connection portion between the inclined surface 24a and the front end surface 24b, and is a portion of the peak portion 24 that is farthest from the shaft portion 23. The top portion 24c can be said to be an edge portion in the above-described truncated cone shape of the peak portion 24.

The uneven portion 22 has a surface in which a surface 33a of the shaft portion 23, the rear end surface 24d of the peak portion 24, the inclined surface 14a thereof, and the front end surface 24b thereof are alternately repeated from the LDb side toward the LDa side.

Further, it is preferable that the inclined surface 14a and the inclined surface 24a are parallel to each other in a state where the peak portion 24 is inserted between two adjacent peak portions 14 when viewed from the side illustrated in FIG. 1 (when viewed from a direction perpendicular to the axes X1 and X2). It is preferable that the dimensions of the peak portion 24 are the same as those of the peak portion 14 of the inner mold 10. The term “same” as used herein is intended to mean that the dimensions of the peak portion 24 are the same as those of the peak portion 14 within a measurement limit or a design limit.

In each valley fold portion of the bellows structure of the straw body, the top portion 24c of the peak portion 24 forms a ridge line. In the mold set 100 in accordance with one or more embodiments, the top portion 24c of each peak portion 24 has a rounded surface. For this reason, even if an outer surface of the straw body is strongly brought into contact with the uneven portion 22 due to pressing by the outer mold 20, cracks are less likely to occur in the ridge line portion of the bellows structure. This makes it possible to bring the top portion 24c of the uneven portion 22 into contact with the outer surface of the straw body with a strong force in order to form a bend portion of the bellows structure without cracks.

From the viewpoint of bringing the top portion 24c of the uneven portion 22 into contact with a strong force, a radius of curvature of the rounded surface of the top portion 24c may be 0.01 mm to 1.00 mm, or 0.05 mm to 0.20 mm. Furthermore, it is preferable that the radius of curvature of the rounded surface of the top portion 24c is the same as that of the rounded surface of the top portion 14c. The radius of curvature of the rounded surface of the top portion 24c is, for example, 0.10 mm.

In the mold set 100, in the LD direction, a length L2 of each peak portion 24 of the uneven portion 22 may be 1.50 mm to 1.80 mm, 1.55 mm to 1.77 mm, or 1.60 mm to 1.75 mm. Further, it is preferable that the length L2 is the same as the length L1 of the peak portion 14. Setting the length L2 within the above numerical range makes it possible to achieve a valley fold that can be folded at a ridge line, even if the thickness of the valley fold portion is relatively large. A bellows structure can be formed even on a straw body having a relatively large wall thickness. The length L2 is, for example, 1.64 mm.

As an inclination angle θ2 of the inclined surface 24a with respect to the shaft portion 23 increases, the top portion 24c of the uneven portion 22 can be brought into contact with the outer surface of the straw body with a greater force. From this viewpoint, the inclination angle θ2 may be 30.00 to 40.0°, or 30.0° to 35.0°. Furthermore, it is preferable that the inclination angle θ2 is the same as the inclination angle θ1. The inclination angle θ2 is, for example, 31.07°.

The larger a distance H2 between the top portion 24c and the shaft portion 23 is, the deeper a recessed groove formed by two adjacent peak portions 24 becomes. If the depth of the recessed groove is great, the top portion 24c of the uneven portion 22 can be brought into contact with the outer surface of the straw body with a strong force. From this viewpoint, the distance H2 between the top portion 24c and the shaft portion 23 may be 1.10 mm to 1.80 mm, or 1.30 mm to 1.70 mm. Furthermore, it is preferable that the distance H2 is the same as the distance H1. The distance H2 is, for example, 1.49 mm.

If in the uneven portion 22, a distance (pitch) P2 between two adjacent peak portions 24 is large, the uneven portion 22 enables folding with respect to each valley fold portion having a relatively large thickness at the ridge line thereof. From this viewpoint, the distance P2 between two adjacent peak portions 24 may be 2.20 mm to 2.50 mm, or 2.25 mm to 2.40 mm. Furthermore, it is preferable that the distance P2 is the same as the distance P1. Note that the distance P2 between two adjacent peak portions 24 is intended to mean a distance between two top portions 24c of the two adjacent peak portions 24. The distance P2 is, for example, 2.30 mm.

In two adjacent peak portions 14, a distance D2 between the front end surface 24b of one peak portion 24 and the rear end surface 24d of the other peak portion 24 is not particularly limited, but may be 0.2 mm to 0.8 mm, or 0.3 mm to 0.7 mm. Furthermore, it is preferable that the distance D2 is the same as the distance D1. Setting the distance D2 within the above numerical range makes it possible to provide an effect of enabling reduction of a contact portion between the straw body and a portion of the uneven portion 22 other than the top portions 24c to improve the appearance of the bellows structure. The distance D2 is, for example, 0.6 mm.

As described above, the mold set 100 includes the following configurations (1) and (2). (1) Each peak portion 14 has the top portion 14c having a rounded surface, and each peak portion 24 has a top portion 24c having a rounded surface. (2) In the LD direction, the length L1 of each peak portion 14 is 1.50 mm to 1.80 mm, and the length L2 of each peak portion 24 is 1.50 mm to 1.80 mm. Therefore, according to the mold set 100, the top portions 14c and 24c can be brought into contact with the straw body with a strong force, and furthermore, a bellows structure can be formed even on a straw body having a relatively large wall thickness. Accordingly, it is possible to achieve a straw that can maintain a bellows structure without cracks in ridge line portions, even if the thickness of the bend portions is large. Therefore, according to the mold set 100, a practically usable straw with a bellows structure can be manufactured, even in a case where a straw body made of an aliphatic polyester-based resin such as a biodegradable resin as a raw material is used. Therefore, according to one or more embodiments, it is possible to achieve the mold set 100 usable for manufacturing a straw with a bellows structure using an aliphatic polyester-based resin such as a biodegradable resin as a raw material.

### (Method for Manufacturing Straw)

A straw manufacturing method in accordance with one or more embodiments (hereinafter, may be referred to as the present manufacturing method) includes a bellows structure forming step of forming a bellows structure on a straw body with use of the above-described mold set 100. This makes it possible to manufacture a practically usable straw with a bellows structure, even in a case where a straw body made of an aliphatic polyester-based resin such as a biodegradable resin as a raw material is used.

The present manufacturing method may be any method, provided that the method includes the bellows structure forming step. From the viewpoint of processability of the bellows structure, it is preferable that the bellows structure forming step includes a molding step and a folding step. In the molding step, mountain fold portions and valley fold portions of the bellows structure are molded on the straw body with use of the mold set. Further, in the folding step, the straw body molded in the molding step is compressed, and the mountain fold portions and the valley fold portions are folded to form the bellows structure. Reference numerals 4001 to 4003 of FIG. 4 are views schematically illustrating an example of the bellows structure forming step in the present manufacturing method. The bellows structure forming step includes a preparation step indicated by reference numeral 4001 of FIG. 4, a molding step indicated by reference numeral 4002 of FIG. 4, and a folding step indicated by reference numeral 4003 of FIG. 4.

As indicated by reference numeral 4001 of FIG. 4, in the preparation step, the mold set is set on a tubular straw body 31. In the preparation step, the outer mold 20 is disposed so as to face the uneven portion 12 of the inner mold 10. The straw body 31 is mounted on the inner mold 10 thus disposed. Specifically, the straw body 31 is mounted so that the inner mold 10 is inserted into the straw body 31.

Then, as indicated by reference numeral 4002 of FIG. 4, in the molding step, the outer mold 20 is pressed from an outer side against the straw body 31 inside which the inner mold 10 is mounted, while rotating the inner mold 10 and the outer mold 20 in opposite directions. By these rotation and pressing, valley fold portions 32E and mountain fold portions 32F of a bellows structure 32 are molded on the straw body 31. Thus, a ridge line 32c of each valley fold portion 32E is formed at a contact portion between the straw body 31 and the top portion 14c of the inner mold 10. Further, a ridge line 32d of each mountain fold portion 32F is formed at a contact portion between the straw body 31 and the top portion 24c of the outer mold 20. By the molding step, the valley fold portions 32E and the mountain fold portions 32F are alternately formed on the straw body 31 in the LD direction. With use of the above-described mold set 100, no cracks occur in the ridge line 32c of the valley fold portion 32E and the ridge line 32d of the mountain fold portion 32F in the molding step. Note that the ridge lines 32c and 32d can be expressed as bend lines or fold lines of the valley fold portion 32E and the mountain fold portion 32F in the bellows structure 32.

Here, in the molding step, a rotation speed and a rotation time of the inner mold 10 and the outer mold 20 may be any rotation speed, provided that the ridge lines 32c and 32d are formed on the straw body 31, and the rotation speed and the rotation time can be appropriately set according to the thickness, material, and the like of the straw body 31. For example, the rotation speed of the inner mold 10 and the outer mold 20 may be 50 rpm to 1000 rpm, or 200 rpm to 600 rpm. The rotation time of the inner mold 10 and the outer mold 20 may be 0.5 seconds to 30 seconds, or 1.5 seconds to 10 seconds. More specifically, the rotation speed and the rotation time of the inner mold 10 and the outer mold 20 may be 300 rpm and 5 seconds, respectively.

Further, the outer mold 20 is pressed against the straw body 31 by, for example, further moving the outer mold 20 toward an inner mold 10 side in a state where the outer mold 20 is in contact with the outer surface of the straw body 31. The movement distance of the outer mold 20 toward the inner mold 10 side corresponds to a pressing amount of the outer mold 20 into the straw body 31. The pressing amount of the outer mold 20 may be any rotation speed, provided that the ridge lines 32c and 32d are formed on the straw body 31, and the pressing amount can be appropriately set according to the thickness, material, and the like of the straw body 31. For example, for the straw body 31 having a wall thickness of 0.16 mm to 0.20 mm, the pressing amount of the outer mold 20 may be 0.1 mm to 1.0 mm, or 0.2 mm to 0.8 mm.

As illustrated in reference numeral 4003 of FIG. 4, in the folding step, the inner mold 10 and the outer mold 20 are removed from the straw body 31 molded in the molding step. Then, the straw body 31 is compressed from both sides. The valley fold portions 32E and the mountain fold portions 32F are thus compressed, and the bellows structure 32 is formed on the straw body 31. With use of the above-described mold set 100, no cracks occur in the ridge line 32c of each valley fold portion 32E and the ridge line 32d of each mountain fold portion 32F due to the compression in the folding step.

### (Straw Body 31)

Here, according to the present manufacturing method, in the above-described bellows structure forming step, it is preferable that the straw body 31 has an elastic modulus of 1300 MPa to 2200 MPa and a breaking strain of 200% to 600%. Since the elastic modulus and the breaking strain of the straw body 31 are within the specific numerical ranges as described above, effects of excellent processability of the bellows structure 32 are provided. Specific effects are, for example, as follows. (1) In the molding step, the bend portions (the valley fold portions 32E or the mountain fold portions 32F) of the straw body 31 are not crushed. (2) In the folding step, no cracks occur in the ridge lines 32c and 32d of the bend portions of the straw body 31 (the bellows structure 32 does not tear at the ridge lines 32c or 32d).

The elastic modulus and the breaking strain are calculated based on an S—S curve obtained by performing a tensile test on a dumbbell-shaped film cut out from the straw body 31 with use of a tensile tester (EZ-LX 1 kN, manufactured by Shimadzu Corporation) according to JIS K 7127 under a condition of a tensile speed of 100 mm/min.

The elastic modulus may be 1400 MPa to 2100 MPa, or 1500 MPa to 2000 MPa. Further, the breaking strain may be 200% to 500%, or 240% to 500%.

It is preferable that the present manufacturing method further includes a step of forming the straw body 31 (straw body forming step), and a curing step of storing, under a predetermined curing condition (curing time, curing temperature, and the like), the straw body 31 formed in the straw body forming step, until the bellows structure forming step. The values of the elastic modulus and the breaking strain can be controlled, for example, by adjusting the curing time for the straw body 31 in the curing step. The longer the curing time is, the higher the elastic modulus tends to become. Further, the longer the curing time is, the smaller the breaking strain tends to become.

The curing time is not particularly limited, provided that the elastic modulus and the breaking strain can be set within the respective numerical ranges described above, but the curing time may be 1 day to 24 days, or 2 days to 15 days. Further, the curing temperature is not particularly limited, provided that the elastic modulus and the breaking strain can be set within the respective numerical ranges described above, but the curing temperature may be −20° C. to 50° C., or 0° C. to 30° C.

Further, in a case where the above aliphatic polyester-based resin is a P3HA-based resin, the values of the elastic modulus and the breaking strain can also be controlled by, for example, adjusting an average content ratio of other hydroxyalkanoate units in all monomer units constituting the P3HA-based resin component.

### (Straw)

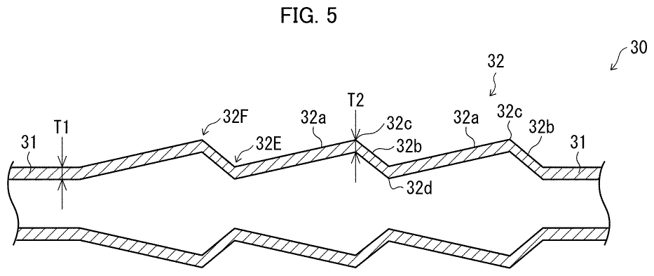

FIG. 5 is a cross-sectional view mainly illustrating a schematic configuration of a bellows structure 32 of a straw 30 in accordance with one or more embodiments. The straw 30 can be manufactured by, for example, the present manufacturing method, that is, the method for manufacturing a straw with use of the above-described mold set 100.

As illustrated in FIG. 5, the straw 30 has a configuration in which the bellows structure 32 is formed on the tubular straw body 31 containing an aliphatic polyester-based resin. The aliphatic polyester-based resin contained in the straw body 31 will be described later.

The bellows structure 32 includes the plurality of valley fold portions 32E and the plurality of mountain fold portions 32F that are alternately disposed in the axial direction of the straw body 31. In a cross-sectional shape along the axial direction of the straw body 31, that is, in the cross-sectional shape illustrated in FIG. 5, the bellows structure 32 has a corrugated wall portion in which long side portions 32a and short side portions 32b are alternately connected. Both the valley fold portion 32E and the mountain fold portion 32F are constituted by the long side portion 32a and the short side portion 32b. In the valley fold portion 32E and the mountain fold portion 32F, portions corresponding to the ridge lines 32c and 32d are both connection portions between the long side portion 32a and the short side portion 32b. In the valley fold portion 32E, the portion corresponding to the ridge line 32c is disposed on an outer side, whereas in the mountain fold portion 32F, the portion corresponding to the ridge line 32d is disposed on an inner side.

Here, in the straw 30 in accordance with one or more embodiments, a wall thickness T1 of the straw body 31 may be 0.18 mm to 0.22 mm, or 0.185 mm to 0.205 mm. Setting the wall thickness of the straw body 31 within the above numerical range makes it possible to achieve the straw 30 that can maintain the bellows structure 32 without cracks in the ridge lines 32c and 32d. Thus, the straw 30 is usable for manufacturing a straw with a bellows structure using an aliphatic polyester-based resin such as a biodegradable resin as a raw material.

Further, in a cross-sectional shape along the axial direction of the straw body 31, that is, in the cross-sectional shape illustrated in FIG. 5, a ratio of the length of the long side portion 32a to the length of the short side portion 32b may be 1.50 to 2.50, or 1.70 to 2.30. Setting the ratio of the length of the long side portion 32a to the length of the short side portion 32b within the above numerical range makes it possible to achieve the straw 30 that can maintain the bellows structure 32 without cracks in the ridge lines 32c and 32d.

Further, a wall thickness T2 of the portions corresponding to the ridge lines 32c and 32d, that is, the connection portion between the long side portion 32a and the short side portion 32b, may be 0.040 mm to 0.120 mm, or 0.070 mm to 0.110 mm. Setting the wall thickness of the connection portion between the long side portion 32a and the short side portion 32b within the above numerical range makes it possible to achieve the straw 30 that can maintain the bellows structure 32 without cracks in the ridge lines 32c and 32d.

### (Thermoplastic Resin)

A straw body that is a target of the mold set 100 in accordance with one or more embodiments, that is, a straw body used in the present manufacturing method, and a straw in accordance with one or more embodiments are made of a thermoplastic resin. The thermoplastic resin is not particularly limited. Suitable examples of thermoplastic resin include not only general-purpose resins such as polypropylene, polyethylene, polyvinyl chloride, polyvinyl acetate, polyacetal, polycarbonate, polyamide, acrylonitrile, butadiene, polystyrene, and acrylic polymers but also biodegradable resins such as P3HA-based resin, polylactic acid, polyglycol acid, polybutylene succinate, polybutylene succinate adipate, polybutylene adipate terephthalate, polybutylene succinate terephthalate, and polycaprolactone. It is possible to use one type of the above thermoplastic resins alone or to use two or more types of the thermoplastic resins in combination.

In particular, it is preferable that the straw (straw body) in accordance with the one or more embodiments contains an aliphatic polyester-based resin. Further, the aliphatic polyester-based resin may be a poly(3-hydroxyalkanoate)-based resin (hereinafter, also referred to as P3HA-based resin). In the present specification, the “P3HA-based resin” refers to a polyhydroxyalkanoate, which includes, as a repeating unit, a 3-hydroxyalkanoic acid repeating unit represented by the general formula: (—CHR—CH₂—CO—O—) (where R is an alkyl group represented by CₙH₂ₙ₊₁, and n is an integer of 1 to 15).

More specifically, the P3HA-based resin may include a 3-hydroxybutyrate (3HB) unit. It is preferable that the P3HA-based resin including a 3HB unit be selected from the group consisting of poly(3-hydroxybutyrate) (P3HB), poly(3-hydroxybutyrate-co-3-hydroxyvalerate) (P3HB3HV), poly(3-hydroxybutyrate-co-3-hydroxyhexanoate) (P3HB3HH), poly(3-hydroxybutyrate-co-3-hydroxyvalerate-co-3-hydroxyhexanoate) (P3HB3HV3HH), poly(3-hydroxybutyrate-co-4-hydroxybutyrate) (P3HB4HB), poly(3-hydroxybutyrate-co-3-hydroxyoctanoate), and poly(3-hydroxybutyrate-co-3-hydroxydecanoate). It is possible to include only one type of the above P3HA-based resins or to include two or more types of the P3HA-based resins in combination.

The P3HA-based resin may be a P3HA-based resin (microbially produced P3HA-based resin) which is produced by microorganisms. The microbially produced P3HA-based resin usually consists only of a polyhydroxyalkanoate monomer unit of the D-form (R-form). Among microbially produced P3HA-based resins, P3HB, P3HB3HH, P3HB3HV, P3HB3HV3HH, and P3HB4HB are preferable, and P3HB, P3HB3HH, P3HB3HV, and P3HB4HB are more preferable, from the viewpoint of ease of industrial production.

The P3HA-based resin can also be produced by a method disclosed, for example, in International Publication No. WO 2010/013483. Commercially available products of the P3HA-based resin include, for example, “KANEKA Biodegradable Polymer PHBH (registered trademark)” of Kaneka Corporation.

Further, the P3HA-based resin includes at least one kind of copolymer of a 3HB unit and another hydroxyalkanoate unit, and a composition ratio of the above 3-hydroxybutyrate unit in the poly(3-hydroxyalkanoate)-based resin may be in a range of 65.0 mol % to 99.0 molo, in a range of 68.0 mol % to 98.5 mol %, in a range of 70.0 mol % to 98.5 mol, or in a range of 70.0 mol % to 98.0 molo, with respect to all the repeating units (100 mol %).

In a case where the composition ratio of the 3HB repeating unit is not less than 90.0 mol %, the P3HA-based resin is likely to have further improved rigidity, a faster crystallization speed, reduced burrs, and improved productivity. On the other hand, in a case where the composition ratio of the 3HB repeating unit is not more than 99.0 mol %, the melting point is less than the thermal decomposition temperature, so that stable and continuous production becomes possible. Note that a monomer composition ratio of the P3HA-based resin can be measured by gas chromatography or the like (for example, see International Publication No. WO 2014/020838).

The molecular weight of the P3HA-based resin is not particularly limited as long as substantially sufficient physical properties for an intended application are exhibited. A range of the weight average molecular weight of the P3HA-based resin may be from 100,000 to 1,000,000, from 150,000 to 700,000, from 200,000 to 500,000, or from 250,000 to 450,000. In a case where the weight average molecular weight is not less than 100,000, moderate mechanical strength is obtained. Further, when the molecular weight is not more than 1,000,000, an increase in melt viscosity can be suppressed, and thus moldability is excellent.

The weight average molecular weight can be determined, as a polystyrene equivalent molecular weight, measurement method in which: gel permeation chromatography (GPC) (“Shodex GPC-101” manufactured by Showa Denko K.K.) is used; polystyrene gel (“Shodex K-804” manufactured by Showa Denko K.K.) is used in a column; and chloroform is used as a mobile phase. At this time, a calibration curve is prepared with use of respective polystyrenes having weight average molecular weights of: 31,400; 197,000; 668,000; and 1,920,000. As the column in the GPC, a column suitable for measuring the molecular weight may be used.

Further, the material of the straw (straw body) in accordance with one or more embodiments may include an additive that can be used together with the thermoplastic resin within a range that does not hinder the effect of one or more embodiments of the present invention. Examples of the additive include: inorganic fillers such as talc, calcium carbonate, mica, and silica; colorants such as pigments and dyes; odor absorbing agents such as activated carbon and zeolite; perfumes such as vanillin and dextrin; plasticizers; oxidation inhibitors; antioxidants; weather resistance improvers; ultraviolet absorbers; crystal nucleating agents; lubricants; mold release agents; water repellent agents; antibacterial agents; and slidability improving agents. It is possible to include only one type of the above additives or to include two or more of the above additives in combination. The content of these additives can be set, as appropriate, by a person skilled in the art according to the purpose of use.

According to one or more embodiments, in a case where the P3HA-based resin is used as a raw material of the straw (straw body), marine contamination due to disposal can be suppressed. This makes it possible to contribute to achieving, for example, Sustainable Development Goals (SDGs) such as Goal 12 “Ensure sustainable consumption and production patterns” and Goal 14 “Conserve and sustainably use the oceans, seas and marine resources for sustainable development”.

The straw body used in the present manufacturing method can be manufactured by a known method with use of a resin composition containing the above-described aliphatic polyester-based resin. The straw body can be manufactured, for example, by the following method. A melting step of melting a resin composition containing an aliphatic polyester-based resin in an extruder. A forming step of, after the melting step, extruding the resin composition from an annular die connected to an outlet of the extruder, putting the resin composition into water to solidify it, so that the resin composition is formed into a tubular shape.

The present invention is not limited to the embodiments, but can be altered by a skilled person in the art within the scope of the claims. The present invention also encompasses, in its technical scope, any embodiment derived by combining technical means disclosed in differing embodiments.

That is, one or more embodiments of the present invention are as follows.
<1> A mold set 100 for forming a bellows structure 32 on a straw body 31 having a tubular shape, the mold set including:
an inner mold 10 having a rod shape and configured to be inserted into the straw body 31; and
an outer mold 20 having a rod shape and configured to press the straw body 31 from an outer side, in which
the inner mold 10 has a first uneven portion (uneven portion 12) that forms mountain fold portions 32F of the bellows structure 32,
the first uneven portion includes
a first shaft (shaft portion 13) extending in an axial direction (LD direction) of the straw body and
a plurality of first peak portions (peak portions 14) protruding in a radial direction (RD1 direction) of the inner mold 10 with respect to the first shaft portion and provided at a predetermined interval in the axial direction of the straw body 31,
the outer mold 20 has a second uneven portion (uneven portion 22) that forms valley fold portions 32E of the bellows structure 32,
the second uneven portion includes
a second shaft portion disposed in parallel with the first shaft portion (shaft portion 23) and
a plurality of second peak portions (peak portions 24) protruding in a radial direction (RD2 direction) of the outer mold 20 with respect to the second shaft portion, each of the plurality of second peak portions being inserted between two adjacent first peak portions (peak portions 14),
each of the plurality of first peak portions has a first top portion (top portion 14c) having a rounded surface, each of the plurality of second peak portions has a second top portion (top portion 24c) having a rounded surface,
in the axial direction of the straw body 31, each of the plurality of first peak portions has a length L1 of 1.50 mm to 1.80 mm, and
in the axial direction of the straw body 31, each of the plurality of second peak portions has a length L2 of 1.50 mm to 1.80 mm.
<2> The mold set 100 described in <1>, in which each of the plurality of first peak portions has a first inclined surface (inclined surface 14a) extending from the first top portion, each of the plurality of second peak portions has a second inclined surface (inclined surface 24a) extending from the second top portion,
an inclination angle θ1 of the first inclined surface with respect to the first shaft portion is 30.0° to 40.0°, and
an inclination angle θ2 of the second inclined surface with respect to the second shaft portion is 30.00 to 40.0°.
<3> The mold set 100 described in <1> or <2>, in which a distance H1 between the first top portion and the first shaft portion is 1.10 mm to 1.80 mm, and
a distance H2 between the second top portion and the second shaft portion is 1.10 mm to 1.80 mm.
<4> The mold set 100 described in any one of <1> to <3>, in which a distance P1 between two adjacent first peak portions (peak portions 14) is 2.20 mm to 2.50 mm, and
a distance P2 between two adjacent second peak portions (peak portions 24) is 2.20 mm to 2.50 mm
<5> The mold set 100 described in any one of <1> to <4>, in which the straw body 31 contains an aliphatic polyester-based resin.
<6> The mold set 100 described in <5>, in which the aliphatic polyester-based resin is a poly(3-hydroxyalkanoate)-based resin.
<7> A method for manufacturing a straw 30, the method comprising a bellows structure forming step of forming a bellows structure 32 on a straw body 31 with use of the mold set 100 described in any one of <1> to <6>.
<8> The method described in <7>, in which in the bellows structure forming step, the straw body 31 has an elastic modulus of 1300 MPa to 2200 MPa and a breaking strain of 200% to 600%.
<9> The method described in <8>, in which the bellows structure forming step comprises:
a molding step of molding mountain fold portions 32F and valley fold portions 32E of the bellows structure 32 on the straw body 31 with use of the mold set 100; and
a folding step of compressing the straw body 31 molded in the molding step, and folding the mountain fold portions 32F and the valley fold portions 32E to form the bellows structure 32.
<10> The method described in <9>, in which
the molding step comprises a pressing step of pressing the outer mold 20 from an outer side against the straw body 31 inside which the inner mold 10 is mounted, while rotating the inner mold 10 and the outer mold 20 in opposite directions.
<11> The method described in any one of <7> to <10>, further including: a straw body forming step of forming the straw body 31; and
a curing step of storing, under a predetermined curing condition, the straw body 31 formed in the straw body forming step, until the bellows structure forming step.
<12> The method described in <11>, in which in the curing step, the predetermined curing condition includes the following: a curing time is 1 day to 24 days, and a curing temperature is −20° C. to 50° C.
<13> A straw 30 in which a bellows structure 32 is formed on a straw body 31 having a tubular shape and containing an aliphatic polyester-based resin, the straw body 31 having a wall thickness T1 of 0.18 mm to 0.22 mm.
<14> The straw 30 described in <13>, in which in a cross-sectional shape of the straw body 31 along an axial direction (LD direction),
the bellows structure 32 has a corrugated wall portion in which a long side portion 32a and a short side portion 32b are alternately connected, and
a ratio of a length of the long side portion 32a to a length of the short side portion 32b is 1.50 to 2.50.
<15> The straw 30 described in <14>, in which a connection portion (portion corresponding to ridge line 32c, 32d) between the long side portion 32a and the short side portion 32b has a wall thickness T2 of 0.040 mm to 0.120 mm.

### EXAMPLES

Hereinafter, one or more embodiments of the present invention will be described in more detail on the basis of Examples, but the present invention is not limited to these Examples.

Substances used in Examples and Comparative Examples are shown below.

[Poly(3-hydroxyalkanoate)-based resin] PHB: poly(3-hydroxybutyrate) (weight average molecular weight is 300,000 g/mol)
produced in accordance with the method described in Comparative Example 1 of International Publication No. WO 2004/041936.
P3HB3HH-3:P3HB3HH (average content ratio 3HB/3HH=97.1/2.9 (mol %/mol %), weight average molecular weight is 300,000 g/mol)
produced in accordance with the method described in Example 2 of International Publication No. WO 2019/142845.
P3HB3HH-13:P3HB3HH (Kaneka Biodegradable Polymer PHBH (registered trademark)) (average content ratio 3HB/3HH=87.1/12.9 (mol %/mol %), weight average molecular weight is 330,000 g/mol)
P3HB3HH-30: P3HB3HH (average content ratio 3HB/3HH=70.5/29.5 (mol %/mol %), weight average molecular weight is 640,000 g/mol)
produced in accordance with the method described in Example 9 of International Publication No. WO 2019/142845.

### [Additives]

Additive-1: Behenamide (BNT-22H, manufactured by Nippon Fine Chemical Co., Ltd.)
Additive-2: Erucamide (NEUTRON-S, manufactured by Nippon Fine Chemical Co., Ltd.)

### [Plasticizer]

Plasticizer: Glycerin diacetomonolaurate (BIOCIZER, manufactured by Riken Vitamin Co., Ltd.)

### [Others]

A tube made of polybutylene succinate (PBS) and a tube made of cellulose acetate were prepared, and these tubes were used as straw bodies. These tubes both have an outer diameter of 6 mm and a wall thickness of 0.2 mm.

### 1. Preparation of Resin Composition Pellets

To a material obtained by blending 12.0 parts by weight of PHB, 52.2 parts by weight of P3HB3HH-3, 22.8 parts by weight of P3HB3HH-30, and 13.0 parts by weight of P3HB3HH-13, 1.0 part by weight of Additive-1, 0.5 parts by weight of Additive-2, and 4.3 parts by weight of the plasticizer were added and blended.

The resin material (resin mixture) thus obtained was put into a 026 mm co-rotating twin-screw extruder in which a cylinder temperature and a die temperature were both set to 150° C., and a strand of the resin material was extruded at 20 kg/hour. The extruded resin material was passed through a water bath filled with hot water at 40° C. to solidify the strand, and the strand was cut with use of a pelletizer to obtain resin composition pellets.

### 2. Forming of Tube (Straw Body)

A cylinder temperature and a die temperature of a φ50 mm single-screw extruder to which an annular die (outer diameter: 15 mm, inner diameter: 13.5 mm) was connected were each set to 160° C., and the resin composition pellets were put into the extruder and extruded into a tubular shape. The extruded tube was passed through a water bath at 40° C. located at a position 100 mm away from the annular die, and was taken up at speeds of 25 m/min, 30 m/min, and 40 m/min. As a result, tubes having an outer diameter of 6 mm and a length of 200 mm, with respective wall thicknesses of 0.16 mm, 0.18 mm, and 0.20 mm, were obtained.

### 3. Processing of Bellows Structure

To process the bellows structure, a set of paired molds (see FIG. 1) mounted on an inner side and an outer side of the straw body was used.

Preparation step: each tube with a different wall thickness produced in 2. was inserted onto a rod-shaped inner mold, and a movable outer mold having the same shape as that of the inner mold was pressed also from an outer side of the tube.

Molding step: The outer mold was movable in a direction perpendicular to a longitudinal direction of the tube. After coming into contact with the outer surface of the tube, the outer mold was further pressed in. Then, in this state, the outer mold and the inner mold were rotated in opposite directions at 300 rpm for 5 seconds, thereby molding a bellows structure on the tube. After the rotation of the inner mold and the outer mold had been finished, the outer mold was separated from the tube, and the tube was removed from the inner mold. Note that conditions for a pressing amount after the outer mold had come into contact with the outer surface of the tube were 0.30 mm and 0.60 mm.

Folding step: Next, the tube was inserted onto a column-side compression pin, and a force was applied to the tube in the longitudinal direction to compress the tube, thereby folding the bellows structure.

### 4. Dimensions of Mold Set to be Used

The dimensions of the mold set used for processing the bellows structure will be described with reference to FIG. 2 and FIG. 3.

### Mold Set #1

Inner mold 10: The length L1 of the peak portion 14 was 1.34 mm. The inclination angle θ1 of the inclined surface 14a with respect to the shaft portion 13 was 27.18°. The distance H1 between the top portion 14c and the shaft portion 13 was 1.00 mm. The distance P1 between two adjacent peak portions 14 was 2.00 mm. No rounded surface was formed on the top portion 14c.

Outer mold 20: The length L2 of the peak portion 24 was 1.34 mm. The inclination angle θ2 of the inclined surface 24a with respect to the shaft portion 23 was 27.18°. The distance H2 between the top portion 24c and the shaft portion 23 was 1.00 mm. The distance P2 between two adjacent peak portions 24 was 2.00 mm. No rounded surface was formed on the top portion 24c.

### Mold Set #2

Inner mold 10: The length L1 of the peak portion 14 was 1.64 mm. The inclination angle θ1 of the inclined surface 14a with respect to the shaft portion 13 was 31.07°. The distance H1 between the top portion 14c and the shaft portion 13 was 1.20 mm. The distance P1 between two adjacent peak portions 14 was 2.30 mm. The top portion 14c was rounded to have a radius of curvature of 0.1 mm.

Outer mold 20: The length L2 of the peak portion 24 was 1.64 mm. The inclination angle θ2 of the inclined surface 24a with respect to the shaft portion 23 was 31.07°. The distance H2 between the top portion 24c and the shaft portion 23 was 1.20 mm. The distance P2 between two adjacent peak portions 24 was 2.30 mm. The top portion 24c was rounded to have a radius of curvature of 0.1 mm.

### 5. Evaluation of Processability of Bellows Structure

Evaluation of processability of the bellows structure is as follows.
“Formable”: In the folding step, the tube can be folded at ridge lines of the mountain fold portions and the valley fold portions in the bellows structure.
“Not formable”: In the folding step, the tube cannot be folded at ridge lines of the mountain fold portions and the valley fold portions in the bellows structure.
“Crack”: Regardless of “Formable” and “Not formable” above, a crack occurs at ridge lines of the mountain fold portions and the valley fold portions in the bellows structure.

### Example 1

As the straw body, the tube with a wall thickness of 0.16 mm produced in 2. was used. With use of mold set #2, a bellows structure was processed in accordance with 3., with a pressing amount of 0.3 mm after the outer mold had come into contact with the outer surface of the tube. Then, processability of the bellows structure was evaluated in accordance with 5.

### Examples 2 to 7 and Comparative Examples 1 to 5

A bellows structure was processed in the same manner as in Example 1, except that the wall thickness of the tube used as a straw body, the type of the mold set used for processing the bellows structure, and the pressing amount after the outer mold had come into contact with the outer surface of the tube were changed to the conditions described in Table 1. Then, processability of the bellows structure was evaluated in accordance with 5.

Evaluation results of the processability of the bellows structure are shown in Table 1.

TABLE 1

| | Examples | | | | | |
|---|---|---|---|---|---|---|
| | 1 | 2 | 3 | 4 | 5 | 6 |
| Evaluation of processability of | Formable | Formable | Formable | Formable | Formable | Formable |
| bellows structure | | | | | | |
| Wall thickness of straw body | 0.16 | 0.18 | 0.20 | 0.16 | 0.18 | 0.20 |
| [mm] | | | | | | |
| Pressing amount of outer | 0.3 | 0.3 | 0.3 | 0.6 | 0.6 | 0.6 |
| mold [mm] | | | | | | |
| Mold set used | # 2 | # 2 | # 2 | # 2 | # 2 | # 2 |

Comparative Examples

| | 1 | 2 | 3 | 4 | 5 |
|---|---|---|---|---|---|
| Evaluation of processability of | Not | Not | Crack | Crack | Crack |
| bellows structure | formable | formable | | | |
| Wall thickness of straw body | 0.18 | 0.20 | 0.16 | 0.18 | 0.20 |
| [mm] | | | | | |
| Pressing amount of outer | 0.3 | 0.3 | 0.6 | 0.6 | 0.6 |
| mold [mm] | | | | | |
| Mold set used | # 1 | # 1 | # 1 | # 1 | # 1 |

### Examples 8 to 12 and Comparative Examples 6 to 9

Evaluation methods performed in Examples 8 to 12 and Comparative Examples 6 to 9 will be described below.

### [Tensile Test: Calculation of Elastic Modulus and Breaking Strain]

The produced tubes were each cut to form a film, and the film was cut into a No. 8 dumbbell shape according to JIS K 6251. Then, a tensile test was performed on the cut film with use of a tensile tester (EZ-LX 1 kN, manufactured by Shimadzu Corporation) according to JIS K 7127 under a condition of a tensile speed of 100 mm/min. A tensile modulus and a breaking strain were calculated based on an S—S curve obtained by the tensile test.

### [Evaluation of Processability of Bellows Structure]

Evaluation of processability of the bellows structure is as follows.
“Crushed”: In the folding step, a portion other than ridge lines of the mountain fold portions and the valley fold portions in the bellows structure is bent.
“Crack”: In the molding step or the folding step, a crack is observed at the ridge lines of the mountain fold portion and the valley fold portion.
“No problem” In the folding step, a portion at the ridge lines of the mountain fold portions and the valley fold portions is bent and a bellows structure can be formed with no cracks observed at the ridge lines.

### Example 8

As a straw body, a tube produced in 2, and cured for 1 hour was used. The straw body was processed to have a bellows structure in accordance with 3., and processability of the bellows structure was evaluated. For the straw body, a tensile test was performed to calculate an elastic modulus and a breaking strain.

Evaluation results of the elastic modulus and the breaking strain of the straw body, and the processability of the bellows structure are shown in Table 2.

### Examples 9 to 11 and Comparative Examples 6 to 8

A bellows structure was processed in the same manner as in Example 8, except that a curing time of the tube produced in 2. as the straw body was changed to the time shown in Table 2. For the straw body, a tensile test was performed to calculate an elastic modulus and a breaking strain.

Evaluation results of the elastic modulus and the breaking strain of the straw body, and the processability of the bellows structure are shown in Table 2.

### Example 12

A bellows structure was processed in the same manner as in Example 8, except that a tube made of polybutylene succinate was used as a straw body, and a curing time was changed to the time shown in Table 2. For the straw body, a tensile test was performed to calculate an elastic modulus and a breaking strain.

Evaluation results of the elastic modulus and the breaking strain of the straw body, and the processability of the bellows structure are shown in Table 2.

### Comparative Example 9

A bellows structure was processed in the same manner as in Example 8, except that a tube made of cellulose acetate was used as a straw body, and a curing time was changed to the time shown in Table 2. For the straw body, a tensile test was performed to calculate an elastic modulus and a breaking strain.

Evaluation results of the elastic modulus and the breaking strain of the straw body, and the processability of the bellows structure are shown in Table 2.

TABLE 2

| | Examples | | | | |
|---|---|---|---|---|---|
| | 8 | 9 | 10 | 11 | 12 |
| Raw material of straw body | PHBH | PHBH | PHBH | PHBH | PBS |
| Elastic modulus [MPa] | 1444 | 1516 | 1600 | 1616 | 1695 |
| Breaking strain [%] | 316 | 348 | 291 | 295 | 269 |
| Curing time [day(s)] | 1 | 3 | 6 | 7 | 30 |
| Evaluation of processability of | No | No | No | No | No |
| bellows structure | problem | problem | problem | problem | problem |

| | Comparative Examples | | | |
|---|---|---|---|---|
| | 6 | 7 | 8 | 9 |
| Raw material of straw body | PHBH | PHBH | PHBH | Cellulose |
| | | | | acetate |
| Elastic modulus [MPa] | 1720 | 1207 | 1249 | 2866 |
| Breaking strain [%] | 198 | 324 | 353 | 55 |
| Curing time [day(s)] | 25 | 0.05 | 0.25 | 35 |
| Evaluation of processability of | Crack | Crushed | Crushed | Crack |
| bellows structure | | | | |

From the results shown in Table 2, it was found that in a case where the elastic modulus of the straw body was 1300 MPa to 2000 MPa and the breaking strain of the straw body was 200% to 600%, there was no problem in the processability of the bellows structure.

### INDUSTRIAL APPLICABILITY

One or more embodiments of the present invention can be used in the field of straw manufacturing.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

### REFERENCE SIGNS LIST

10 Inner mold
12 Uneven portion (first uneven portion)
13 Shaft portion (first shaft portion)
14 Peak portion (first peak portion)
14a Inclined surface (first inclined surface)
14c Top portion (first top portion)
20 Outer mold
22 Uneven portion (second uneven portion)
23 Shaft portion (second shaft portion)
24 Peak portion (second peak portion)
24a Inclined surface (second inclined surface)
24c Top portion (second top portion)
30 Straw
31 Straw body
32 Bellows structure
32a Long side portion
32b Short side portion
32c, 32d Ridge line (connection portion between long side portion and short side portion)
32E Mountain fold portion
32F Valley fold portion
100 Mold set

1. A mold set for forming a bellows structure on a straw body having a tubular shape, comprising:
an inner mold having a rod shape and configured to be inserted into the straw body; and
an outer mold having a rod shape and configured to press the straw body from an outer side, wherein:
the inner mold has a first uneven portion configured to form mountain fold portions of the bellows structure, the first uneven portion includes:
a first shaft portion extending in an axial direction of the straw body and
a plurality of first peak portions protruding in a radial direction of the inner mold with respect to the first shaft portion and provided at a predetermined interval in the axial direction of the straw body,
the outer mold has a second uneven portion configured to form valley fold portions of the bellows structure, the second uneven portion includes:
a second shaft portion disposed in parallel with the first shaft portion and
a plurality of second peak portions protruding in a radial direction of the outer mold with respect to the second shaft portion, each of the plurality of second peak portions configured to be inserted between two adjacent first peak portions,
each of the plurality of first peak portions has a first top portion having a rounded surface,
each of the plurality of second peak portions has a second top portion having a rounded surface,
in the axial direction of the straw body, each of the plurality of first peak portions has a length of 1.50 mm to 1.80 mm, and
in the axial direction of the straw body, each of the plurality of second peak portions has a length of 1.50 mm to 1.80 mm.

2. The mold set according to claim 1, wherein:
each of the plurality of first peak portions has a first inclined surface extending from the first top portion,
each of the plurality of second peak portions has a second inclined surface extending from the second top portion,
an inclination angle of the first inclined surface with respect to the first shaft portion is 30.0° to 40.0°, and
an inclination angle of the second inclined surface with respect to the second shaft portion is 30.0° to 40.0°.

3. The mold set according to claim 1, wherein:
a distance between the first top portion and the first shaft portion is 1.10 mm to 1.80 mm, and
a distance between the second top portion and the second shaft portion is 1.10 mm to 1.80 mm.

4. The mold set according to claim 1, wherein:
a distance between two adjacent first peak portions is 2.20 mm to 2.50 mm, and
a distance between two adjacent second peak portions is 2.20 mm to 2.50 mm.

5. The mold set according to claim 1, wherein the straw body comprises an aliphatic polyester-based resin.

6. The mold set according to claim 5, wherein the aliphatic polyester-based resin is a poly(3-hydroxyalkanoate)-based resin.

7. A method for manufacturing a straw, comprising forming a bellows structure on a straw body with the mold set according to claim 1.

8. The method according to claim 7, wherein the straw body has an elastic modulus of 1300 MPa to 2200 MPa and a breaking strain of 200% to 600%.

9. The method according to claim 8, wherein the forming the bellows structure comprises:
molding the mountain fold portions and the valley fold portions of the bellows structure with the mold set; and
compressing the molded straw body and folding the mountain fold portions and the valley fold portions to form the bellows structure.

10. The method according to claim 9, wherein the molding comprises pressing the outer mold from an outer side against the straw body inside which the inner mold is mounted, while rotating the inner mold and the outer mold in opposite directions.

11. The method according to claim 7, further comprising:
forming the straw body; and
storing the straw body under a predetermined curing condition until forming the bellows structure.

12. The method according to claim 11, wherein the predetermined curing condition includes a curing time of 1 day to 24 days and a curing temperature of −20° C. to 50° C.

13. A straw comprising a straw body having a tubular shape and a bellows structure on the straw body, wherein:
the straw body comprises an aliphatic polyester-based resin, and
the straw body has a wall thickness of 0.18 mm to 0.22 mm.

14. The straw according to claim 13, wherein:
in a cross-sectional shape of the straw body along an axial direction,
the bellows structure has a corrugated wall portion in which a long side portion and a short side portion are alternately connected, and
a ratio of a length of the long side portion to a length of the short side portion is 1.50 to 2.50.

15. The straw according to claim 14, wherein a connection portion between the long side portion and the short side portion has a wall thickness of 0.040 mm to 0.120 mm.
